(19) United States
(12) Patent Application Publication
(10) Pub. No.: US 2004/0259506 A1
(43) Pub. Date: Dec. 23, 2004

(54) Walkie talkie which vibrates when receiving incoming control signals

(76) Inventors: Jany-Yee Hsu, Tou-Liu City (TW); Ming-Hui Chen, Chang-Hua Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/463,665

(22) Filed: Jun. 18, 2003

(51) Int. Cl. H04M 1/00; H04B 1/38

(52) U.S. Cl. 455/90.2; 455/567

(57) ABSTRACT

A walkie-talkie set includes a first walkie-talkie and a second walkie-talkie. The first walkie-talkie includes a user interface having a push-to-talk button and a microphone for receiving voice signals when the button is depressed, a processor, and a transceiver for emitting a control signal generated by the processor and the voice signals received from the microphone. The second walkie-talkie includes a casing, a transceiver, and a vibration motor for vibrating the casing when receiving the control signal from the first walkie-talkie.

### BACKGROUND OF INVENTION

1. Field of the Invention

The present invention relates to a walkie-talkie, and more specifically, to a walkie-talkie capable of vibrating when being called.

2. Description of the Prior Art

A continuous tone-coded squelch system (CTCSS) has been widely applied to wireless transmission, and is used to make a plurality of users communicate with each other within a predetermined communication area. The CTCSS adopts a low-frequency CTCSS tone signal to distinguish signals transmitted via the same physical channel. For instance, a prior art walkie-talkie utilizes the CTCSS to achieve group communication. Please refer to FIG. 1, which is a schematic diagram showing frequency bands used by the prior art CTCSS. As shown in FIG. 1, a band ranging from 62.5 Hz to 250 Hz is used to transmit the above-mentioned low-frequency CTCSS tone signal, and another band ranging from 300 Hz to 3.4 KHz is used to transmit speech signals spoken by a user. The operation of the CTCSS is described as follows. With regard to the prior art walkie-talkie, 14 channels P₁-P₁₄ generally are adopted to carry signals, and the 14 channels are physical channels. In addition, 38 CTCSS tone signals T₁-T₃₈ individually corresponding to different frequencies are used. One of the 38 CTCSS tone signals T₁-T₃₈ annexed to one physical channel generates a specific logical channel, and the 14 physical channels are capable of forming 532 (14*38) logical channels in total. When a speaker sets the walkie-talkie with a physical channel P₁ and a desired CTCSS tone signal T₁, that is, the logical channel set by the speaker becomes P₁ (T₁). After the speaker presses a push-to-talk (PTT) button on the walkie-talkie, the speaker is capable of outputting speech signals via the walkie-talkie toward the predetermined communication area specified by the walkie-talkie. Suppose there are three listeners in the predetermined communication area, and the three listener set their own logical channels as P₁ (T₁), P₁ (T₃₈), P₂ (T₁) respectively. For the first listener with a logical channel P₁ (T₁), because his walkie-talkie receives and transmits signals through the physical channel P₁, the walkie-talkie of the first listener will start receiving speech signals spoken by the speaker. In addition, the walkie-talkie of the first listener judges that the CTCSS tone signal used by the speaker is T₁. In other words, the speaker and the first listener both adopt the same logical channel P₁ (T₁). Therefore, the walkie-talkie of the first listener then outputs the received speech signals via an audio speaker. The first listener is capable of hearing the speech signals spoken by the speaker. For the second listener with a logical channel P₁ (T₃₈), because his walkie-talkie receives and transmits signals through the physical channel P₁, the walkie-talkie of the second listener will start receiving speech signals spoken by the speaker. However, the walkie-talkie of the second listener judges that the CTCSS tone signal used by the speaker is not T₁, but T₃₈. In other words, the speaker and the second listener adopt different logical channels P₁ (T₁) and P₁ (T₃₈). Therefore, the walkie-talkie of the second listener then does not output the received speech signals via an audio speaker. The second listener cannot hear the speech signals spoken by the speaker. For the third listener with a logical channel P₂ (T₁), because his walkie-talkie receives and transmits signals through the physical channel P₂, the walkie-talkie of the third listener and that of the speaker use different physical channels. With the unmatched physical channel, the walkie-talkie of the third listener cannot acknowledge an adequate signal strength indicated by a received signal strength indicator (RSSI). Therefore, the walkie-talkie of the third listener will not receive any speech signals spoken by the speaker. That is, no speech signal is played by an audio speaker of the walkie-talkie. The second and third listeners cannot hear any speech signals spoken by the speaker, that is, the walkie-talkies of the second and third listeners both detect the CTCSS tone signal related to the received speech signals for actuating a signal squelch function. To sum up, only the users using the same logical channel can communicate with each other to achieve group communication.

Please refer to FIG. 2, which is a block diagram of a prior art walkie-talkie 10. The walkie-talkie 10 has an antenna 11, a transceiver 12, a selector 14, a CTCSS decoder 16, a CTCSS encoder 18, a speech signal processor 20, a speaker 22, a microphone 24, and a controller 26. The walkie-talkie 10 can receive and transmit radio frequency (RF) signals through the antenna 11. With regard to receiving RF signals, the transceiver 12 converts the high-frequency RF signal into a low-frequency baseband signal Rx, and transmits the baseband signal Rx to the selector 14. The selector 14 then outputs the baseband signal Rx from an output port A. The CTCSS decoder 16 determines frequency of a CTCSS tone signal according to the received baseband signal Rx. Generally speaking, the CTCSS decoder 16 has a low-pass filter (LPF) for extracting signals with frequencies ranging from 62.5 Hz to 250 Hz, and then the CTCSS decoder 16 judges the CTCSS tone signal related to the baseband signal Rx to decide whether the walkie-talkie 10 and the baseband signal Rx use the same logical channel. At the same time, the decoder 16 sends a judgment result to the controller 26. If the walkie-talkie 10 and the baseband signal Rx use the same logical channel, the controller 26 activates the speaker 22 to proceed following signal output operation. That is, the speech signal processor 20 has two analog filter circuits for extracting signals with frequencies ranging from 300 Hz to 3.4 KHz, and the extracted signals are played by the speaker 22. On the contrary, if the walkie-talkie 10 and the baseband signal Rx use different logical channels, the controller 26 does not actuate the speech signal processor 20 and the speaker 22. The walkie-talkie 10, therefore, does not output any speech signals transmitted by unmatched logical channels. With regard to transmitting RF signals, when the user presses the PTT button, the selector 14 will chose the input port B, and the controller 26 simultaneously actuates the microphone 24. Therefore, the speech signals spoken by the user are inputted into the speech signal processor 20. As mentioned above, the speech signal processor 20 uses filter circuits to extract signals with frequencies ranging from 300 Hz to 3.4 KHz, and the speech signal processor 20 outputs the extracted signals to the CTCSS encoder 18. Based on a CTCSS code (CTCSS tone signal with a specific frequency) set in the walkie-talkie 10, the CTCSS encoder 18 adds a corresponding CTCSS tone signal in the extracted signals outputted from the speech signal processor 20 for forming a baseband signal Tx. In the end, the transceiver 12 converts the low-frequency baseband signal Tx into a high-frequency RF signal, and the RF signal is then outputted via the antenna 11.

The walkie-talkie does not have a ring sound, unlike the telephone, while someone is calling. Therefore, it is possible that the listener will miss what the speaker speaks if voice of the speaker is not loud enough, resulting in omitting some information. Furthermore, under certain special situations, for example, while an infant in baby room, but his parents in host bedroom, because the baby cannot know to press the push-to-talk button to answer his parents who want to know baby's condition, this is a disadvantage of using a conventional walkie-talkie or a telephone.

### SUMMARY OF INVENTION

It is therefore a primary objective of the claimed invention to provide a walkie-talkie capable of vibrating when received a control signal to solve the aforementioned problem.

Briefly summarized, the claimed invention provides a walkie-talkie set comprising a first walkie-talkie and a second walkie-talkie. The first walkie-talkie includes a user interface having a push-to-talk button and a microphone for receiving voice signals when the button is depressed, a processor, and a transceiver for emitting a control signal generated by the processor and the voice signals received from the microphone. The second walkie-talkie includes a casing, a transceiver and a vibration motor for vibrating the casing when receiving the control signal from the first walkie-talkie.

The other objective of the claimed invention walkie-talkie is to provide a walkie-talkie capable of turning on the microphone at the end of communication to receive the speech signal when receiving a control signal from the end of transmission.

The claimed invention also provides a walkie-talkie set comprising a first walkie-talkie and a second walkie-talkie. The first walkie-talkie comprises a user interface for inputting a defined control signal, and a transceiver for transmitting the control signal. The user interface comprises a button and a microphone capable of receiving speech signal while the button is being triggered. The second walkie-talkie comprises a microphone for inputting speech signal, a transceiver for receiving the control signal and transmitting the speech signal, and a mode switch capable of turning on the microphone of the second walkie-talkie while receiving the control signal generated by the first walkie-talkie, such that the speech signal inputted via the microphone is capable of transmitting from the transceiver of the second walkie-talkie to the transceiver of the first walkie-talkie.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram showing frequency bands used by the prior art CTCSS.

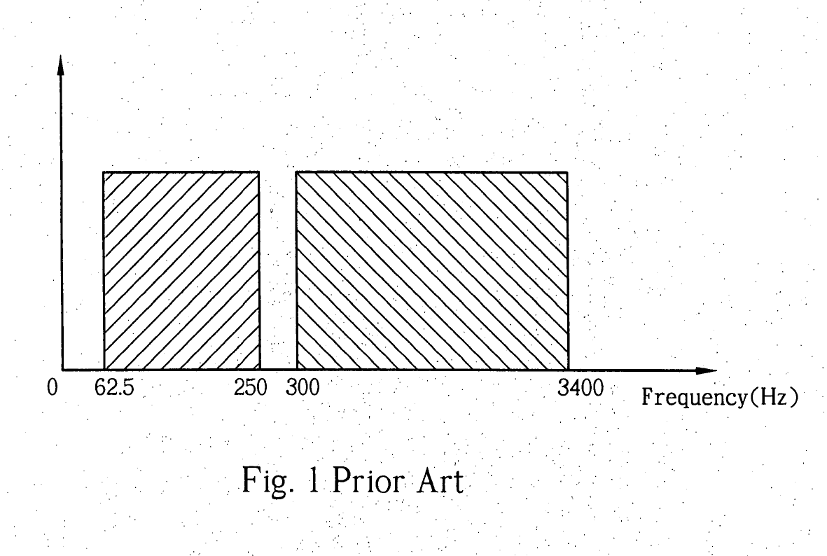

FIG. 2 is a block diagram of a prior art walkie-talkie.

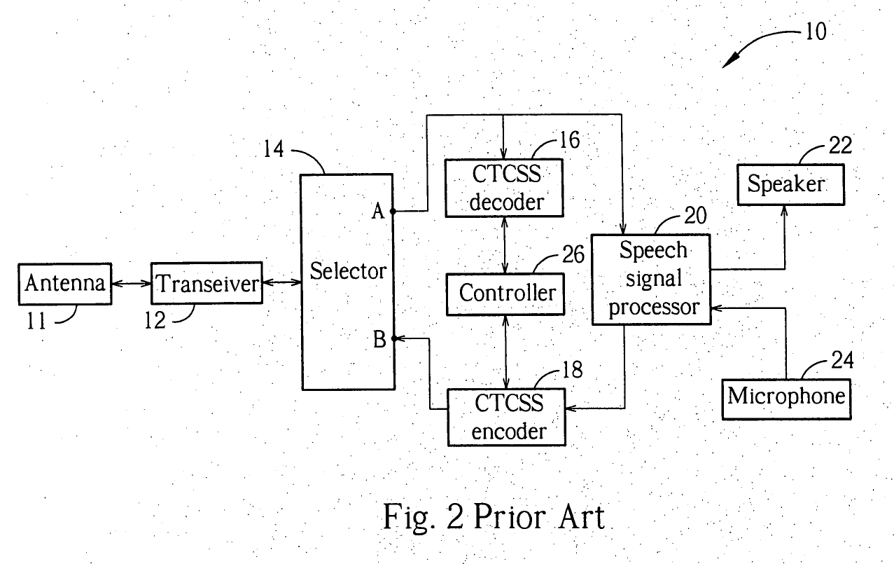

FIG. 3 is a schematic diagram of the walkie-talkie set according to the present invention.

FIG. 4 is a block diagram of the first embodiment of the walkie-talkie set according to the present invention.

FIG. 5 is a block diagram of the second embodiment of the walkie-talkie set according to the present invention.

### DETAILED DESCRIPTION

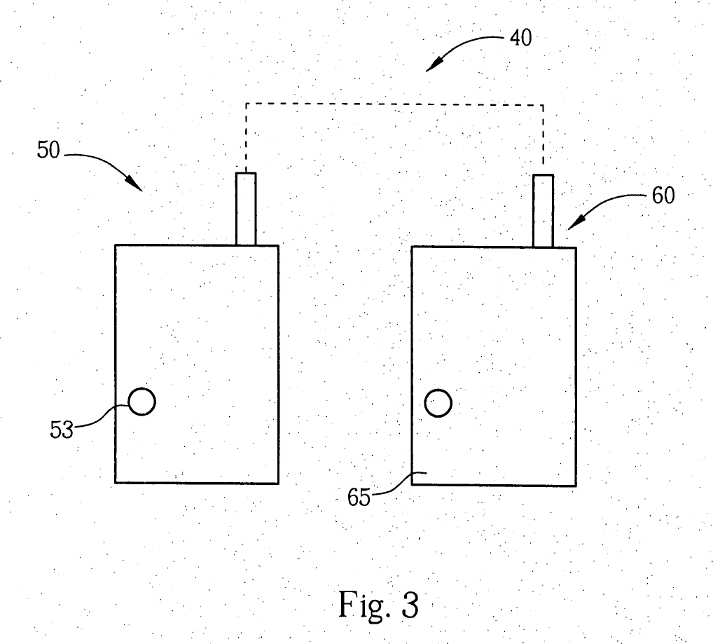

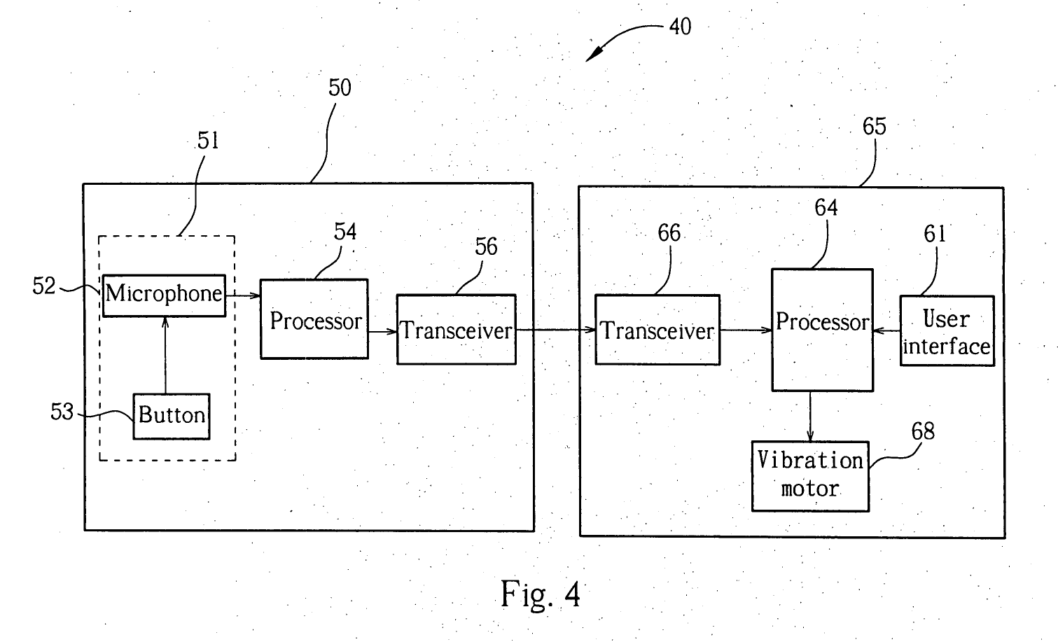

Please refer to FIG. 3 and FIG. 4. FIG. 3 is a schematic diagram of a walkie-talkie set 40, and FIG. 4 is a block diagram of the walkie-talkie set 40. The walkie-talkie set 40 comprises a first walkie-talkie 50 and a second walkie-talkie 60. The first walkie-talkie 50 comprises a user interface 51 having a button 53 and a microphone 52 which is used to receive the speech signal while the button 53 is being pressed, a processor 54 for generating a control signal, and a transceiver 56 for transmitting the control signal and the speech signal from the microphone 52. The second walkie-talkie 60 comprises a user interface 61, a processor 64, a transceiver 66 for receiving both the control signal and the speech signal from the first walkie-talkie 50, a casing 65, and a vibration motor 68 for vibrating the casing while receiving the control signal from the first walkie-talkie 50 via the transceivers 56, 66. The user interface 61 is used for receiving input signal.

Assume that the walkie-talkie set 40 is set to operate under the physical channel P₁ and to use the speech signal T₁, i.e. logical channel P₁ (T₁). When a user using the first walkie-talkie 50 wants to talk to another user using the second walkie-talkie 60, the processor 54 generates a control signal with defined frequency in a range between 2500 KHz and 3500 Khz when the button 53 of the first walkie-talkie 50 is triggered. Afterwards, the control signal is sent by the transceiver 56 and received by the transceiver 66 of the second walkie-talkie 60. After receiving and ensuring the control signal, the processor 64 controls the housing 65 to be vibrated by using the vibration motor 68, which informs the user using the second walkie-talkie 60 of someone intending to talk to the user with the first walkie-talkie 50 who can respond to the user with the second walkie-talkie 60 by triggering the push-to-talk (PTT) button of the second walkie-talkie 60. Certainly, the user with the second walkie-talkie 60 can talk with the user with the first walkie-talkie 50 by triggering the user interface 61. Notice that the push-to-talk (PTT) button could be the button 53 or another button of the user interface 51.

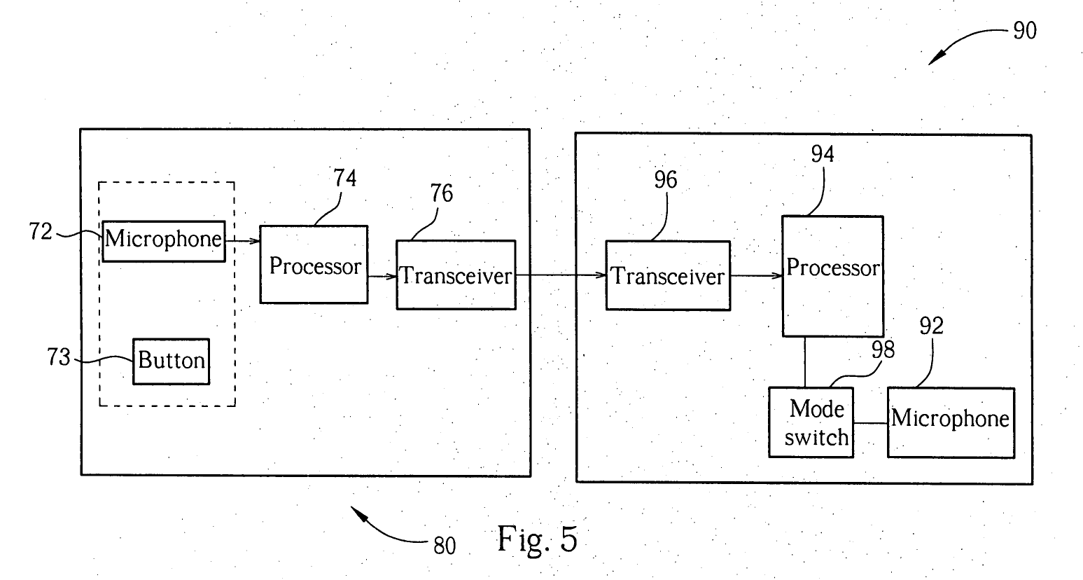

Please refer to FIG. 5, which shows a block diagram of a second embodiment of the walkie-talkie set 80. The walkie-talkie set 80 comprises a first walkie-talkie 70 having a user interface 71, a processor 74 and a transceiver 76, and a second walkie-talkie 90 having a processor 94,a transceiver 96 for receiving the control signal generated by the processor 74 of the first walkie-talkie 70 and for transmitting speech signals, a mode switch 98, and a microphone 92 for receiving the speech signals. The user interface 71 comprises a button 73 and a microphone 72 capable of receiving speech signals while the button 73 is being triggered. When the control signal generated by the first walkie-talkie 70 through the transceivers 76 and 96 is received by the mode switch 98, the microphone 92 of the second walkie-talkie 90 is turned on. Therefore, the inputted speech signal by the microphone 92 is capable of being transmitted to the first walkie-talkie 70 through the transceiver 96 of the second walkie-talkie 90 and the transceiver 76 of the first walkie-talkie 70.

Assume that the walkie-talkie set 80 is set to operate under the physical channel P₁ and to use the speech signal T₁₀, i.e. logical channel P₁ (T₁₀). Suppose the user using the walkie-talkie 70 just wants to know the situation of the user using the second walkie-talkie 90 instead of talking to him. The user using the walkie-talkie 70 is capable of triggering the button 73, and then a defined control signal with 2000 KHz-2500 KHz is generated by the processor 74. Afterwards, the control signal is sent via the transceiver 76, received by the transceiver 96 of the second walkie-talkie 90, and checked by the processor 94, so that the microphone 92 of the second walkie-talkie 90 is turned on to received surrounding speech signal which is then sent to the first walkie-talkie 70 via the transceiver 96. In this way, because of reception of the speech signal from the second walkie-talkie 90, the user using the first walkie-talkie 70 is able to know the situation of the user using the second walkie-talkie 90 anytime without any response from the second walkie-talkie 90. Until the user using the walkie-talkie 70 does not need to receive the speech signal from the second walkie-talkie 90 any more, the user using the first walkie-talkie 70 can trigger the button of the first walkie-talkie 70 to generate the control signal again, and the mode switch 98 will turn off microphone 92 to stop transmitting speech signal to the first walkie-talkie 70 when the control signal is received by the processor 94 of the second walkie-talkie 90 again.

In contrast to prior art, the present invention walkie-talkie has ring sound while being called. The listener does not worry about missing information if the listener is busy with something or if the sound from the speaker is too low. The present invention walkie-talkie is also capable of turning on the microphone after receiving a defined control signal from the end of transmission to automatically receive speech signal and to send the speech signal back to the end of transmission. In this way, the user at the end of transmission is capable of knowing what the user at the end of the communication happen anytime.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A walkie-talkie set comprising:
a first walkie-talkie comprising:
a user interface having a button and a microphone capable of receiving speech signal while the button is being triggered;
a processor for generating a control signal; and
a transceiver for transmitting the control signal and the speech signal received by the microphone; and
a second walkie-talkie comprising:
a housing;
a transceiver for receiving the control signal and the speech signal; and
a vibration motor for vibrating the housing when the second walkie-talkie receives the control signal from the first walkie-talkie.

2. The walkie-talkie set of claim 1 wherein the second walkie-talkie further comprises a user interface for receiving input signal while the second walkie-talkie is vibrating.

3. The walkie-talkie set of claim 1 wherein the first walkie-talkie further comprises a button, and when the button is triggered, the processor of the first walkie-talkie generates the control signal.

4. A walkie-talkie comprising:
a housing;
a user interface comprising a button and a microphone for receiving speech signal while the button is being triggered;
a transceiver for transceiving wireless signal;
a vibration motor for vibrating the housing while receiving the control signal received by the transceiver; and
a processor for controlling the operation of the walkie-talkie.

5. A walkie-talkie set comprising:
a first walkie-talkie comprising:
a user interface for inputting a defined control signal, the user interface comprising a button and a microphone capable of receiving speech signal while the button is being triggered; and
a transceiver for transmitting the control signal; and
a second walkie-talkie comprising:
a microphone for inputting speech signal;
a transceiver for receiving the control signal and transmitting the speech signal; and
a mode switch capable of turning on the microphone of the second walkie-talkie while receiving the control signal generated by the first walkie-talkie, such that the speech signal inputted via the microphone is capable of being transmitted from the transceiver of the second walkie-talkie to the transceiver of the first walkie-talkie.

6. A walkie-talkie comprising:
a microphone for receiving speech signal;
a transceiver for receiving a defined control signal and for transmitting the speech signal; and
a mode switch capable of turning on the microphone while receiving the control signal, such that the speech signal inputted via the microphone is capable of outputting the speech signal via the transceiver.
